(19) United States
(12) Patent Application Publication
(10) Pub. No.: US 2022/0033646 A1
(43) Pub. Date: Feb. 3, 2022

(54) Flame Resistant and Hydrolysis Resistant Polyester Composition and Connectors Made Therefrom

(71) Applicant: Celanese International Corporation, Irving, TX (US)

(72) Inventors: Qamer Zia, Raunheim (DE); Dirk Zierer, Hattersheim (DE); Kirsten Markgraf, Weinheim (DE); Patrick Nickolay, Villmar (DE)

(21) Appl. No.: 17/389,577

(22) Filed: Jul. 30, 2021

Related U.S. Application Data
(60) Provisional application No. 63/058,527, filed on Jul. 30, 2020.

(51) Int. Cl. C08L 67/02; C08L 79/08; C08G 63/183; C08K 7/14; C08K 9/06; C08K 5/5313; C08K 5/3492; C08K 5/56; C08K 5/00

(52) U.S. Cl. CPC C08L 67/02; C08L 79/08; C08G 63/183; C08K 7/14; C08K 9/06; C08K 5/5313; C08L 2205/08; C08K 5/56; C08K 5/0066; C08L 2201/02; C08L 2203/20; C08K 2201/003; C08K 2201/004; C08K 5/34924

(57) ABSTRACT

Halogen-free, flame resistant and hydrolysis resistant polymer compositions are disclosed. The polymer composition contains a thermoplastic polymer, such as polybutylene terephthalate. The thermoplastic polymer is combined with a flame retardant that can include a phosphinate, a phosphite, and a nitrogen-containing synergist. In addition, the composition can contain various hydrolysis resistant components. For instance, the polyester polymer incorporated into the composition can have a relatively low amount of carboxyl end groups. In addition, the composition can contain reinforcing fibers that are coated with a hydrolysis resistant agent. The composition can also contain an organometallic compatibilizer.

### RELATED APPLICATIONS

The present application is based upon and claims priority to U.S. Provisional Patent Application Ser. No. 63/058,527, having a filing date of Jul. 30, 2020, which is incorporated herein by reference.

### BACKGROUND

Engineering thermoplastics are often used in numerous and diverse applications in order to produce molded parts and products. For instance, polyester polymers and polyester elastomers are used to produce all different types of molded products, such as injection molded products, blow molded products, and the like. Polyester polymers, for instance, can be formulated in order to be chemically resistant, to have excellent strength properties and, when formulating compositions containing polyester elastomers, to be flexible. Of particular advantage, polyester polymers can be melt processed due to their thermoplastic nature. In addition, polyester polymers can be recycled and reprocessed.

One problem faced by those skilled in the art in producing molded parts and products from thermoplastic polymers is the ability to make the articles flame resistant. Although almost a limitless variety of different flame retardants are marketed and sold commercially, selecting an appropriate flame retardant for a particular thermoplastic polymer composition is difficult and unpredictable. Further, many available flame retardants contain halogen compounds, such as bromine compounds, which can produce harsh chemical gases during production.

Another problem faced by those skilled in the art in producing molded parts and products from polyester polymers is the ability to make the articles hydrolysis resistant. Many polyester polymers, for instance, are known to degrade when subjected to repeated contact with water or high humidity environments, especially at elevated temperatures.

One area where flame resistance and hydrolysis resistance are needed, for instance, is when using polyester polymers to design and produce connectors, particularly high-voltage connectors. High-voltage connectors are designed to make a detachable electrical connection with high-voltage components, such as components that make up the electrical drive system of a motor vehicle. High-voltage connectors, for instance, are particularly high in demand due to the evolution of hybrid vehicles, electrical vehicles, and fuel cell vehicles.

Modern electrical drive systems of electric vehicles, for instance, include numerous high-voltage components or assemblies where the high-voltage devices operate at voltages of greater than 300 V. These include in particular power control elements, such as inverters, current converters and/or power converters, a control unit, and/or electronic controller units.

The high-voltage connectors are designed to operate in high-voltage environments while providing protection against electrical shock. These connectors may also need to operate at high temperatures and in high humidity environments. Thus, connector housings need to be flame retardant and hydrolysis resistant.

In view of the above, the present disclosure is directed to polyester compositions having an improved combination of flame retardant properties and hydrolysis resistance.

### SUMMARY

In general, the present disclosure is directed to a polymer composition containing a thermoplastic polymer, such as a polyester polymer, in conjunction with a fire retardant composition and at least one hydrolysis resistant additive. The components of the fire retardant composition are carefully selected in order to produce a polymer composition having improved fire resistant properties. For example, the polymer composition can display a V-0 rating at a thickness of 1.5 mm or at 0.8 mm when tested according to Underwriters Laboratories Test 94. In addition, the polymer composition can display hydrolysis resistant tensile-mechanical and impact properties when subjected to a Hydrolysis Test at 121° C. For instance, the polymer composition can be formulated such that the tensile properties of the composition, such as the tensile modulus, does not decrease by more than about 50% when tested for 168 hours. In addition, the Charpy notched strength of the polymer composition at 23° C. can decrease by no more than about 50% when tested for 168 hours according to a Hydrolysis Test (as described below).

In one embodiment, for instance, the present disclosure is directed to a flame resistant and hydrolysis resistant polymer composition that contains a polyester polymer. The polyester polymer can be present in the polymer composition generally in an amount greater than about 40% by weight, such as in an amount greater than about 45% by weight, such as in an amount greater than about 50% by weight. The polyester thermoplastic polymer may be a polybutylene terephthalate polymer. In one embodiment, a hydrolysis resistant polyester polymer, such as a hydrolysis resistant polybutylene terephthalate polymer may be used. The polyester polymer (e.g. polybutylene terephthalate polymer) can contain a limited amount of carboxyl end groups. The polyester polymer may contain carboxyl end groups in an amount less than about 20 mmol/kg.

In accordance with the present disclosure, the thermoplastic polymer is combined with a non-halogen flame retardant composition comprising a combination of a metal phosphinate, a metal phosphite, and a nitrogen-containing synergist. The metal phosphite, for instance, may comprise aluminum phosphite having the following formula: Al₂(HPO₃)₃. The metal phosphinate, on the other hand, may be a dialkyl phosphinate, such as aluminum diethyl phosphinate. The nitrogen-containing synergist can comprise a melamine, such as melamine cyanurate. In one aspect, the metal phosphinate is present in the polymer composition in an amount from about 5% to about 30% by weight, such as from about 7% to about 25% by weight, such as in an amount from about 7% to about 19% by weight. The metal phosphite can be present in the polymer composition generally in an amount from about 0.01% to about 4% by weight, such as from about 0.1% to about 2% by weight, such as from about 0.2% to about 1.1% by weight. The nitrogen-containing synergist, on the other hand, can be present in the polymer composition generally in an amount from about 0.01% to about 12% by weight, such as from about 2% to about 9% by weight, such as from about 3% to about 8.5% by weight.

The polymer composition can also contain reinforcing fibers, such as glass fibers. The reinforcing fibers can be coated with a sizing composition that comprises a sizing agent combined with a hydrolysis resistant agent. The sizing agent, for instance, can be a silane while the hydrolysis resistant agent can be a glycidyl ester type epoxy resin. In one aspect, the sizing composition can include a second epoxy resin. Glycidyl ester type epoxy resins that can be used as the hydrolysis resistant agent include acrylic acid glycidyl ester, a methacrylic acid glycidyl ester, a phthalic acid diglycidyl ester, a methyltetrahydrophthalic acid diglycidyl ester, or mixtures thereof. The sizing composition can be present on the reinforcing fibers in an amount from about 0.1% to about 4% by weight of the fibers. The reinforcing fibers can generally have an average fiber length of from about 1 mm to about 5 mm, and can have an average fiber diameter of from about 8 microns to about 12 microns.

The polymer composition can also contain an organometallic compatibilizer. The organometallic compatibilizer, for instance, may be a titanate. One example of a titanate that may be used is titanium IV 2-propanolato,tris(dioctyl)phosphato-O. The organometallic compatibilizer can be present in the polymer composition generally in an amount from about 0.05% to about 2.5% by weight. The flame resistant polymer composition can also contain an ester of a carboxylic acid. For example, the ester may be formed by reacting montanic acid with a multifunctional alcohol. The multifunctional alcohol may be ethylene glycol or glycerine. The ester of a carboxylic acid can be present in the polymer composition generally in an amount from about 0.05% to about 8% by weight.

The polymer composition of the present disclosure can have a melt flow rate of at least 3 cm³/10 min, such as greater than about 4 cm³/10 min, when tested at 250° C. and at a load of 2.16 kg.

In one embodiment, the present disclosure is directed to an electrical connector, such as a high-voltage connector, that comprises at least two opposing walls between which a passageway is defined for receiving a contact element. The contact element, for instance, can be a male conductive element or a female conductive element. In accordance with the present disclosure, the at least two opposing walls are formed from the polymer composition as described above.

Other features and aspects of the present disclosure are discussed in greater detail below.

### Definitions

As used herein, the flame resistant properties of a polymer are measured according to Underwriters Laboratories Test 94 according to the Vertical Burn Test. Test plaques can be made at different thicknesses for measuring flame resistance. A rating of V-0 indicates the best rating.

As used herein, the “Hydrolysis Test” is conducted at 121° C. by placing a test plaque in a pressure cooker for a specific length of time, such as 96 hours or 168 hours. The pressure cooker uses moist heat in the form of saturated steam under pressure. The operating range of the pressure cooker is 15 to 21 psi (using the Geared Steam Gauge). The exposure period begins when the pressure steam gauge needle registers within the above operation range (15 to 21 psi). During the test, the temperature can vary from 121° C. to 127° C. After the determined amount of time, the physical properties of the test plaque are measured and compared with initial properties.

The melt flow rate of a polymer or polymer composition is measured according to ISO Test 1133 at a suitable temperature and load, such as at 250° C. and at a load of 2.16 kg or at a load of 5 kg.

The density of a polymer is measured according to ISO Test 1183 in units of g/cm³.

Average particle size (d50) is measured using light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

Charpy impact strength at 23° C. is measured according to ISO Test 179/1eU.

The relative permittivity or dielectric constant is measured at 1 MHz and the dissipation factor is measured at 1 MHz according to IEC Test 60250.

Volume resistivity and surface resistivity are measured according to IEC Test 60093.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a battery pack for an electrical vehicle illustrating the top cover removed; the battery pack employing a high-voltage harness connection structure in one or more embodiments for connecting to other components of a vehicle;

FIG. 2 is a perspective view of one embodiment of a high-voltage connector in accordance with the present disclosure;

FIG. 3 is an alternative embodiment of a high-voltage connector in accordance with the present disclosure; and

FIG. 4 is an embodiment of an electric car incorporating the battery pack of FIG. 1.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a halogen-free, flame resistant and hydrolysis resistant polymer composition. Polymer compositions made in accordance with the present disclosure not only demonstrate superior flammability ratings when tested according to Underwriters Laboratories Tests and are hydrolysis resistant, but also have excellent mechanical properties, including polymer processing properties.

In general, the polymer composition of the present disclosure contains a suitable thermoplastic polymer, such as a polybutylene terephthalate polymer, combined with a flame retardant composition that may contain a metal phosphinate, a metal phosphite, and a nitrogen-containing synergist. In addition to a flame retardant composition, the polymer composition also contains reinforcing fibers and at least one hydrolysis resistant additive or component. For example, in one embodiment, the thermoplastic polymer selected for use in the polymer composition is a hydrolysis resistant polyester polymer that contains a minimum amount of carboxyl end groups. Further, the reinforcing fibers can be coated with a sizing composition that contains a hydrolysis resistant agent. The polymer composition can also contain an organometallic compatibilizer.

The polymer composition of the present disclosure is particularly well suited to manufacturing electrical components, such as high-voltage electrical connectors. Electrical connectors made in accordance with the present disclosure can have a variety of configurations within the scope of the disclosure. As an example, the electrical connector can define a plurality of passageways or spaces between opposing walls. The passageways can accommodate contact elements to facilitate electrical connections. The contact elements, for instance, can be in the form of a male contact element or a female contact element for connecting with an opposing connector.

The need for flame resistant and hydrolysis resistant electrical connectors and other electrical components is dramatically increasing in demand due to the evolution of the automobile and the mass production of hybrid vehicles, electrical vehicles, and/or autonomous vehicles. Electrical vehicles and autonomous vehicles, for instance, require a higher number of high-voltage connections. Many of these high-voltage connectors and other devices operate at voltages greater than 300 V. These connectors are typically part of high-voltage harnesses that extend between various components in the vehicle, such as from one or more battery packs to the electric motor or to other auxiliary systems.

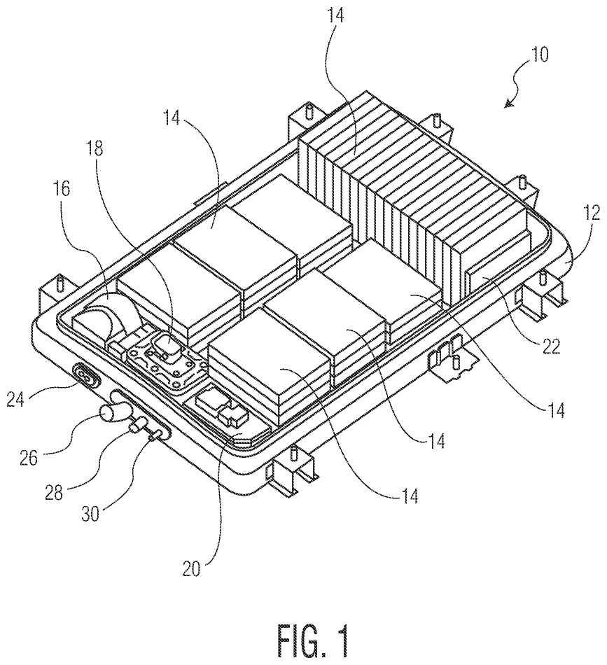

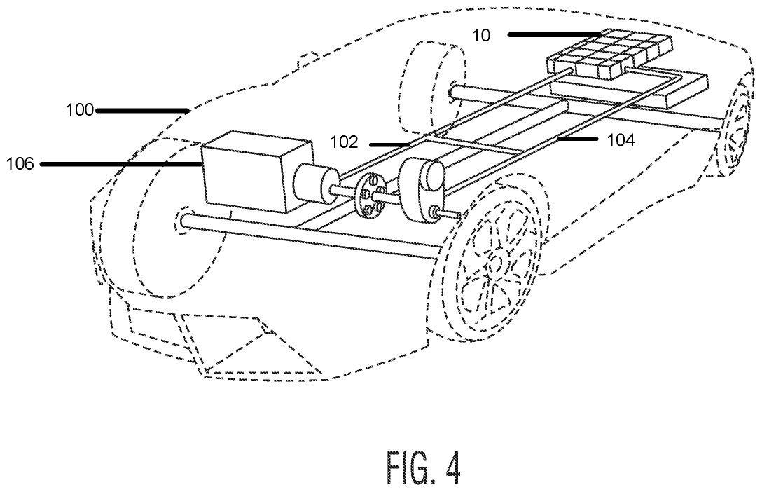

Referring to FIG. 1 and FIG. 4, for instance, one embodiment of a battery pack 10 installed in an electrical vehicle 100 is illustrated. The battery pack 10 includes a battery pack case 12. In the embodiment illustrated, only one portion of the battery pack case 12 is illustrated. The top of the battery pack case 12 has been removed in order to show the interior components.

The battery pack 10 can include a battery module 14, a temperature-adjusted air unit 16, a service disconnect switch 18 which is a high-voltage cut-off switch, a junction box 20, and a lithium ion battery controller 22.

The battery pack case 12 can be mounted in place at any suitable location within a vehicle. In order to connect the battery pack 10 to other components within a vehicle, the battery pack case 12 supports a refrigerant pipe connector terminal 24, a charging/discharging connector terminal 26, a heavy-electric connector terminal 28, and a weak electric connector terminal 30.

The battery module 14 can include a plurality of battery submodules. Each battery submodule is an assembly structure in which a plurality of battery cells are stacked on one another.

One or more high-voltage electric harnesses connect the battery pack 10 to an electric motor contained within the vehicle. For example, as shown in FIG. 4, battery pack 10 is connected to an electric motor 106 via wiring harness 102 and wiring harness 104. In addition to connectors to the battery pack 10, the electric motor of the vehicle can include converter to engine connectors, inverter to heater connectors, inverter to compressor connectors, charger to converter connectors, and the like. All of these components require connectors, particularly high-voltage connectors.

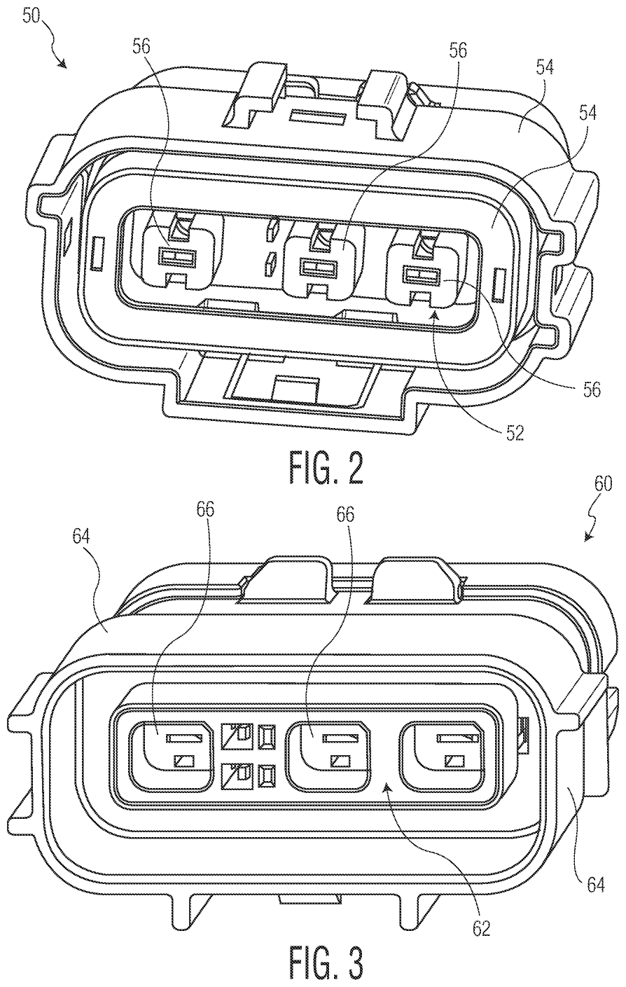

Referring to FIG. 2, one embodiment of a high-voltage connector 50 that may be made in accordance with the present disclosure is shown. The electrical connector 50 includes an insertion passageway 52 surrounded by opposing walls 54. The walls 54 accommodate a plurality of contact elements 56. The contact elements 56 are for making an electrical connection to an opposing connector. In the embodiment illustrated in FIG. 2, the contact elements 56 are male contacts that are to be inserted into opposing receptors.

Referring to FIG. 3, another connector 60 made in accordance with the present disclosure is shown. The connector 60 is for receiving and attaching to the connector 50 as shown in FIG. 2. The connector 60 includes an insertion passageway 62 surrounded by a plurality of opposing walls 64. The connector 60 includes a plurality of contact elements 66. The contact elements 66 are female connectors for receiving the male contact elements 56 from connector 50 as shown in FIG. 2.

In accordance with the present disclosure, the opposing walls 54 of the connector 50 and the opposing walls 64 of the connector 60 can be made from the polymer composition of the present disclosure. The polymer composition has excellent flame resistant properties and is also hydrolysis resistant. For example, when tested according to a Vertical Burn Test according to Underwriters Laboratories Test 94, the polymer composition has a V-0 rating when tested at a thickness of 1.5 mm. In certain embodiments, the polymer composition can also have a rating of V-0 when tested at a thickness of 0.8 mm. The polymer composition can display hydrolysis resistant tensile-mechanical and impact properties when subjected to a Hydrolysis Test at 121° C. For instance, the polymer composition can be formulated such that the tensile properties of the composition, such as the tensile modulus, does not decrease by more than about 50% when tested for 168 hours. In addition, the Charpy notched strength of the polymer composition at 23° C. can decrease by no more than about 50% when tested for 168 hours according to a Hydrolysis Test.

The polymer composition also has excellent mechanical properties. For instance, the tensile modulus of the polymer composition can be greater than about 8,400 MPa, such as greater than about 9,000 MPa, such as greater than about 9,500 MPa, such as greater than about 10,000 MPa, such as greater than about 10,500 MPa, such as greater than about 11,000 MPa. The tensile modulus is generally less than about 18,000 MPa. The polymer composition can have a tensile stress at break of greater than about 110 MPa, such as greater than about 112 MPa, such as greater than about 114 MPa, and generally less than about 130 MPa. The polymer composition can also have a notched Charpy impact strength of greater than about 6 kJ/m², such as greater than about 6.5 kJ/m², such as greater than about 7 kJ/m², such as greater than about 7.5 kJ/m², and generally less than about 14 kJ/m². The polymer composition can have an unnotched Charpy impact strength of generally greater than about 50 kJ/m².

As described above, the polymer composition generally contains a thermoplastic polymer and particularly a polyester polymer. The polyesters which are suitable for use herein are derived from an aliphatic or cycloaliphatic diol, or mixtures thereof, containing from 2 to about 10 carbon atoms and an aromatic dicarboxylic acid, i.e., polyalkylene terephthalates.

The polyesters which are derived from a cycloaliphatic diol and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl)ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

Polyesters that may be used in the polymer composition, for instance, include polyethylene terephthalate, polybutylene terephthalate, mixtures thereof and copolymers thereof.

In one aspect, the polyester polymer, such as the polybutylene terephthalate polymer, contains a relatively minimum amount of carboxyl end groups. For instance, the polyester polymer can contain carboxyl end groups in an amount less than about 20 mmol/kg, such as less than about 18 mmol/kg, such as less than about 15 mmol/kg, and generally greater than about 1 mmol/kg. The amount of carboxyl end groups can be minimized on the polyester polymer using different techniques. For example, in one embodiment, the polyester polymer can be contacted with an alcohol, such as benzyl alcohol, for decreasing the amount of carboxyl end groups.

The polyester polymer or polybutylene terephthalate polymer can generally have a melt flow rate of greater than about 10 cm³/10 min, such as greater than about 30 cm³/10 min, such as greater than about 35 cm³/10 min, and generally less than about 100 cm³/10 min, such as less than about 80 cm³/10 min, such as less than about 60 cm³/10 min, such as less than about 50 cm³/10 min, when tested at 250° C. and at a load of 2.16 kg.

The thermoplastic polymer such as a polybutylene terephthalate polymer is present in the polymer composition in an amount sufficient to form a continuous phase. For example, the thermoplastic polymer may be present in the polymer composition in an amount of at least about 35% by weight, such as in an amount of at least about 40% by weight, such as in an amount of at least 45% by weight, such as in an amount of at least about 50% by weight, such as at least about 55% by weight. The thermoplastic polymer is generally present in an amount less than about 80% by weight.

In accordance with the present disclosure, at least one thermoplastic polymer as described above is combined with a non-halogen flame retardant composition in accordance with the present disclosure. The flame retardant composition can contain a metal phosphinate, a metal phosphite, and a nitrogen-containing synergist.

The metal phosphinate, for instance, may be a dialkyl phosphinate and/or a diphosphinate. The metal phosphinate may have one of the following chemical structures:

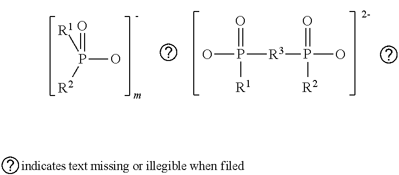

in which R¹, R² are the same or different and are each linear or branched C₁-C₆-alkyl; R³ is linear or branched C₁-C₁₀-alkylene, C₆-C₁₀-arylene, C₇-C₂₀-alkylarylene or C₇-C₂₀-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4.

In one embodiment, the metal phosphinate is a metal dialkylphosphinate, such as aluminum diethylphosphinate. The metal phosphinate can be present in the polymer composition generally in an amount greater than about 5% by weight, such as in an amount greater than about 7% by weight, such as in an amount greater than about 9% by weight, such as in an amount greater than about 11% by weight, and generally in an amount less than about 30% by weight, such as in an amount less than about 25% by weight, such as in an amount less than about 20% by weight, such as in an amount less than about 17% by weight, such as in an amount less than about 14% by weight. In one embodiment, the metal phosphinate is present in the polymer composition in an amount from about 7% to about 19% by weight.

The metal phosphite present in the polymer composition can be any suitable metal phosphite made from any of the metals (M) identified above. In one aspect, the metal phosphite is an aluminum phosphite. The aluminum phosphite can have the following chemical structure: Al₂(HPO₃)₃. Other forms of aluminum phosphite may also be present in the polymer composition. Such other forms include basic aluminum phosphite, aluminum phosphite tetrahydrate, and the like. In still another embodiment, the aluminum phosphite may have the formula: Al(H₂PO₃)₃.

The metal phosphite is believed to synergistically work with the metal phosphinate in improving the flame resistant properties of the polymer composition, especially when the polymer composition contains a polybutylene terephthalate. The weight ratio between the metal phosphinate and the metal phosphite can generally be from about 10:8 to about 30:1, such as from about 10:1 to about 20:1, such as from about 14:1 to about 18:1. In one aspect, the metal phosphite may be present in the polymer composition in an amount greater than about 0.01% by weight, such as in an amount greater than about 0.1% by weight, such as in an amount greater than about 0.2% by weight, such as in an amount greater than about 0.3% by weight, and generally in an amount less than about 4% by weight, such as in an amount less than about 2.5% by weight, such as in an amount less than about 2% by weight, such as in an amount less than about 1.1% by weight.

The nitrogen-containing synergist present in combination with the metal phosphinate and the metal phosphite can comprise a melamine. For instance, the nitrogen-containing synergist may comprise melamine cyanurate. Other melamine compounds that may be used include melamine polyphosphate, dimelamine polyphosphate, melem polyphosphate, melam polyphosphate, melon polyphosphate, and the like. Other nitrogen-containing synergists that may be used include benzoguanamine, tris(hydroxyethyl)isocyanurate, allantoin, glycoluril, guanidine, or mixtures thereof. In general, only small amounts of the nitrogen-containing synergists need to be present in the polymer composition. For instance, the nitrogen-containing synergists can be present in the polymer composition in an amount less than about 12% by weight, such as in an amount less than about 11% by weight, such as in an amount less than about 10% by weight, such as in an amount less than about 9% by weight, such as in an amount less than about 8.5% by weight, and generally in an amount greater than about 0.1% by weight, such as in an amount greater than about 2% by weight, such as in an amount greater than about 3% by weight, such as in an amount greater than about 4% by weight.

The polymer composition may also contain reinforcing fibers dispersed in the thermoplastic polymer matrix. Reinforcing fibers of which use may advantageously be made are mineral fibers, such as glass fibers or polymer fibers, in particular organic high-modulus fibers, such as aramid fibers.

These fibers may be in modified or unmodified form, e.g. provided with a sizing, or chemically treated, in order to improve adhesion to the plastic. Glass fibers are particularly preferred.

The reinforcing fibers, such as the glass fibers, can be coated with a sizing composition to protect the fibers and to improve the adhesion between the fiber and the matrix material. A sizing composition usually comprises silanes, film forming agents, lubricants, wetting agents, adhesive agents, optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes.

In accordance with the present disclosure, the sizing composition applied to the reinforcing fibers can contain not only a silane sizing agent but can also contain a hydrolysis resistant agent. The hydrolysis resistant agent, for instance, can be a glycidyl ester type epoxy resin. For instance, the glycidyl ester type epoxy resin can be a monoglycidyl ester or a diglycidyl ester. Examples of glycidyl ester type epoxy resins that may be used include acrylic acid glycidyl ester, a methacrylic acid glycidyl ester, a phthalic acid diglycidyl ester, a methyltetrahydrophthalic acid diglycidyl ester, or mixtures thereof.

In one aspect, the sizing composition contains a silane, a glycidyl ester type epoxy resin, a second epoxy resin, a urethane resin, an acrylic resin, a lubricant, and an antistatic agent. The second type of epoxy resin, for instance, can be a bisphenol A type epoxy resin. The hydrolysis resistant agent can be present in the sizing composition in relation to the silane sizing agent at a weight ratio of from about 5:1 to about 1:1, such as from about 4:1 to about 2:1.

The reinforcing fibers may be compounded into the polymer matrix, for example in an extruder or kneader.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 12 μm. The length of the fibers can vary depending upon the particular application. For instance, the fibers can have an average length of greater than about 0.5 mm, such as greater than about 1 mm, such as greater than about 1.5 mm, such as greater than about 2.5 mm. The length of the fibers can generally be less than about 8 mm, such as less than about 7 mm, such as less than about 5.5 mm, such as less than about 4 mm.

In general, reinforcing fibers are present in the polymer composition in amounts sufficient to increase the tensile strength of the composition. The reinforcing fibers, for example, can be present in the polymer composition in an amount greater than about 2% by weight, such as in an amount greater than about 5% by weight, such as in an amount greater than about 10% by weight, such as in an amount greater than about 15% by weight, such as in an amount greater than about 20% by weight. The reinforcing fibers are generally present in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight.

The polymer composition can also contain an organometallic compatibilizer. The organometallic compatibilizer has been found to unexpectedly increase hydrolysis resistance and improve the flow properties of the polymer composition during polymer processing. In addition, the organometallic compatibilizer can provide various other benefits and advantages. For instance, the organometallic compatibilizer can provide anti-corrosion properties, increase the acid resistance of the polymer composition, and can improve the long-term aging properties of the polymer composition. In addition, the organometallic compatibilizer can serve as an intumescent flame retardant in certain applications.

The organometallic compatibilizer may comprise a monoalkoxy titanate. Other organometallic compounds that may be used include zirconates and aluminates. Specific examples of titanates that may be incorporated into the polymer composition include Titanium IV 2-propanolato, tris isooctadecanoato-O; Titanium IV bis 2-methyl-2-propenoato-O, isooctadecanoato-O 2-propanolato; Titanium IV 2-propanolato, tris(dodecyl)benzenesulfanato-O; Titanium IV 2-propanolato, tris(dioctyl)phosphato-O; Titanium IV, tris(2-methyl)-2-propenoato-O, methoxydiglycolylato; Titanium IV 2-propanolato, tris(dioctyl)pyrophosphato-O; Titanium IV, tris(2-propenoato-O), methoxydiglycolylato-O; Titanium IV 2-propanolato, tris(3,6-diaza)hexanolato, and mixtures thereof.

When present in the polymer composition, the organometallic compatibilizer can be included in an amount of generally greater than about 0.05% by weight, such as greater than about 0.1% by weight, such as greater than about 0.2% by weight, such as greater than about 0.28% by weight, and generally less than about 2.8% by weight, such as less than about 2.5% by weight, such as less than about 2.2% by weight, such as less than about 1.8% by weight, such as less than about 1.6% by weight, such as less than about 0.7% by weight.

In one embodiment, the polymer composition of the present disclosure can contain a carbodiimide compound. The carbodiimide compound can have a carbodiimide group (—N═C═N—) in the molecule. The carbodiimide compound can provide hydrolysis resistance, especially in relation to epoxy-based compounds. In addition, the carbodiimide compound works well with the flame retardant additives. Applicable carbodiimide compounds include an aliphatic carbodiimide compound having an aliphatic main chain, an alicyclic carbodiimide compound having an alicyclic main chain, and an aromatic carbodiimide compound having an aromatic main chain. An aromatic carbodiimide compound may provide greater resistance to hydrolysis.

Examples of the aliphatic carbodiimide compound include diisopropyl carbodiimide, dioctyldecyl carbodiimide, or the like. An example of the alicyclic carbodiimide compound includes dicyclohexyl carbodiimide, or the like.

Examples of aromatic carbodiimide compound include: a mono- or di-carbodiimide compound such as diphenyl carbodiimide, di-2,6-dimethylphenyl carbodiimide, N-tolyl-N′-phenyl carbodiimide, di-p-nitrophenyl carbodiimide, di-p-aminophenyl carbodiimide, di-p-hydroxyphenyl carbodiimide, di-p-chlorophenyl carbodiimide, di-p-methoxyphenyl carbodiimide, di-3,4-dichlorophenyl carbodiimide, di-2,5-dichlorophenyl carbodiimide, di-o-chlorophenyl carbodiimide, p-phenylene-bis-di-o-tolyl carbodiimide, p-phenylene-bis-dicyclohexyl carbodiimide, p-phenylene-bis-di-p-chlorophenyl carbodiimide or ethylene-bis-diphenyl carbodiimide; and a polycarbodiimide compound such as poly(4,4′-diphenylmethane carbodiimide), poly(3,5′-dimethyl-4,4′-biphenylmethane carbodiimide), poly(p-phenylene carbodiimide), poly(m-phenylene carbodiimide), poly(3,5′-dimethyl-4,4′-diphenylmethane carbodiimide), poly(naphthylene carbodiimide), poly(1,3-diisopropylphenylene carbodiimide), poly(1-methyl-3,5-diisopropylphenylene carbodiimide), poly(1,3,5-triethylphenylene carbodiimide) or poly(triisopropylphenylene carbodiimide). These compounds can be used in combination of two or more of them. Among these, specifically preferred ones to be used are di-2,6-dimethylphenyl carbodiimide, poly(4,4′-diphenylmethane carbodiimide), poly(phenylene carbodiimide), and poly(triisopropylphenylene carbodiimide).

In one aspect, the carbodiimide compound is a polycarbodiimide. For instance, the polycarbodiimide can have a weight average molecular weight of about 10,000 g/mol or greater and generally less than about 100,000 g/mol. Examples of polycarbodiimides include Stabaxol KE9193 and Stabaxol P100 by Lanxess and Lubio AS3-SP by Schaeffe Additive Systems.

The carbodiimide compound can be present in the polymer composition in an amount greater than about 0.3% by weight, such as in an amount greater than about 0.8% by weight, and generally in an amount less than about 4% by weight, such as in an amount less than about 3% by weight, such as in an amount less than about 1.8% by weight.

The thermoplastic polymer composition of the present invention may also include a lubricant that constitutes from about 0.01 wt. % to about 2 wt. %, in some embodiments from about 0.1 wt. % to about 1 wt. %, and in some embodiments, from about 0.2 wt. % to about 0.5 wt. % of the polymer composition. The lubricant may be formed from a fatty acid salt derived from fatty acids having a chain length of from 22 to 38 carbon atoms, and in some embodiments, from 24 to 36 carbon atoms. Examples of such fatty acids may include long chain aliphatic fatty acids, such as montanic acid (octacosanoic acid), arachidic acid (arachic acid, icosanic acid, icosanoic acid, n-icosanoic acid), tetracosanoic acid (lignoceric acid), behenic acid (docosanoic acid), hexacosanoic acid (cerotinic acid), melissic acid (triacontanoic acid), erucic acid, cetoleic acid, brassidic acid, selacholeic acid, nervonic acid, etc. For example, montanic acid has an aliphatic carbon chain of 28 atoms and arachidic acid has an aliphatic carbon chain of 20 atoms. Due to the long carbon chain provided by the fatty acid, the lubricant has a high thermostability and low volatility. This allows the lubricant to remain functional during formation of the desired article to reduce internal and external friction, thereby reducing the degradation of the material caused by mechanical/chemical effects.

The fatty acid salt may be formed by saponification of a fatty acid wax to neutralize excess carboxylic acids and form a metal salt, Saponification may occur with a metal hydroxide, such as an alkali metal hydroxide (e.g., sodium hydroxide) or alkaline earth metal hydroxide (e.g., calcium hydroxide). The resulting fatty acid salts typically include an alkali metal (e.g., sodium, potassium, lithium, etc.) or alkaline earth metal (e.g., calcium, magnesium, etc.). Such fatty acid salts generally have an acid value (ASTM D 1386) of about 20 mg KOH/g or less, in some embodiments about 18 mg KOH/g or less, and in some embodiments, from about 1 to about 15 mg KOH/g. Particularly suitable fatty acid salts for use in the present invention are derived from crude montan wax, which contains straight-chain, unbranched monocarboxylic acids with a chain length in the range of C₂₈-C₃₂. Such montanic acid salts are commercially available from Clariant GmbH under the designations Licomont® CaV 102 (calcium salt of long-chain, linear montanic acids) and Licomont® NaV 101 (sodium salt of long-chain, linear montanic acids).

If desired, fatty acid esters may be used as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. Licowax® OP (Clariant), for instance, contains montanic acids partially esterified with butylene glycol and montanic acids partially saponified with calcium hydroxide. Thus, Licowax® OP contains a mixture of montanic acid esters and calcium montanate. Other montanic acid esters that may be employed include Licowax® E, Licowax® OP, and Licolub® WE 4 (all from Clariant), for instance, are montanic esters obtained as secondary products from the oxidative refining of raw montan wax. Licowax® E and Licolub® WE 4 contain montanic acids esterified with ethylene glycol or glycerine.

Other known waxes may also be employed in a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide, which are commercially available from CasChem, a division of Rutherford Chemicals LLC, under the designations Paricin® 220 and Paricin® 285, respectively.

The polymer composition may also contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol](Irganox® K 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present composition are triazine antioxidants having the following general formula:

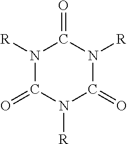

wherein, each R is independently a phenolic group, which may be attached to the triazine ring via a C₁ to C₅ alkyl or an ester substituent. Preferably, each R is one of the following formula (I)-(III):

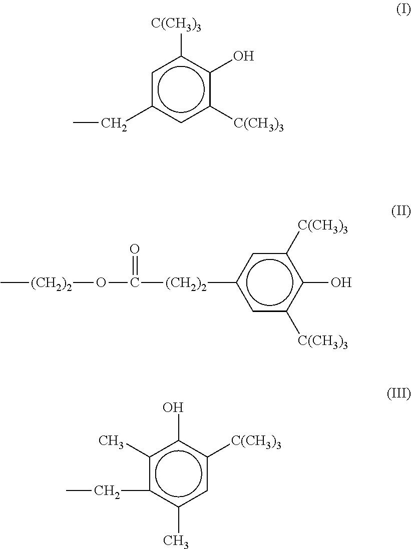

Commercially available examples of such triazine-based antioxidants may be obtained from American Cyanamid under the designation Cyanox® 1790 (wherein each R group is represented by the Formula III) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. %, and in some embodiments, from about 0.05 wt. % to about 0.3 wt. % of the entire stabilized polymer composition. In one embodiment, for instance, the antioxidant comprises pentaerythrityl tetrakis[3-(3,5-di-tert-butyl-4-hydroxyphenyl)propionate.

Hindered amine light stabilizers (“HALS”) may be employed in the composition to inhibit degradation of the polyester composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

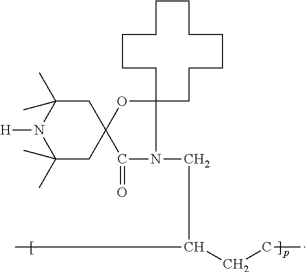

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

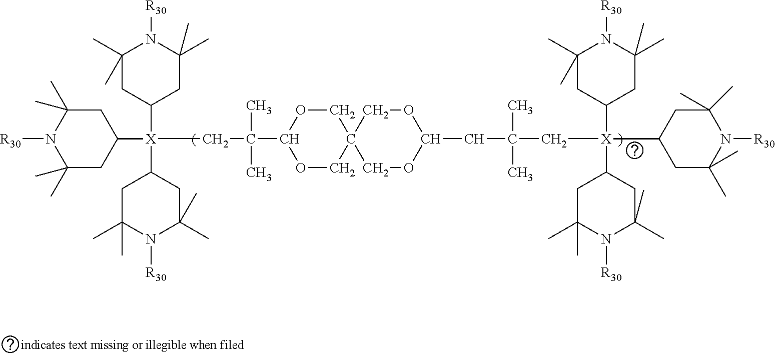

wherein, n is from 1 to 4 and R₃₀ is independently hydrogen or CH₃. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethyl propyl-3-oxy-[4(2,2,6,6-tetramethyl)-piperidinylysiloxane (Uvasil® J299 from Great Lakes Chemical, MW=1100 to 2500); copolymer of α-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl)sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl)ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb® 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl)ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

In one embodiment, the polymer composition may contain a blend of stabilizers that produce ultraviolet resistance and color stability. The combination of stabilizers may allow for products to be produced that have bright and fluorescent colors. In addition, bright colored products can be produced without experiencing significant color fading over time. In one embodiment, for instance, the polymer composition may contain a combination of a benzotriazole light stabilizer and a hindered amine light stabilizer, such as an oligomeric hindered amine.

Organophosphorus compounds may be employed in the composition that serve as secondary antioxidants to decompose peroxides and hydroperoxides into stable, non-radical products. Trivalent organophosphorous compounds (e.g., phosphites or phosphonites) are particularly useful in the stabilizing system of the present invention. Monophosphite compounds (i.e., only one phosphorus atom per molecule) may be employed in certain embodiments of the present invention. Preferred monophosphites are aryl monophosphites contain C₁ to C₁₀alkyl substituents on at least one of the aryloxide groups. These substituents may be linear (as in the case of nonyl substituents) or branched (such as isopropyl or tertiary butyl substituents). Non-limiting examples of suitable aryl monophosphites (or monophosphonites) may include triphenyl phosphite; diphenyl alkyl phosphites; phenyl dialkyl phosphites; tris(nonylphenyl) phosphite (Weston™ 399, available from GE Specialty Chemicals): tris(2,4-di-tert-butylphenyl) phosphite (Irgafos® 168, available from Ciba Specialty Chemicals Corp.); bis(2,4-di-tert-butyl-6-methylphenyl)ethyl phosphite (Irgafos® 38, available from Ciba Specialty Chemicals Corp.); and 2,2′,2″-nitrilo[triethyltris(3,3′5,5′-tetra-tert-butyl-1,1′-biphenyl-2,2′-diyl) phosphate (Irgafos® 12, available from Ciba Specialty Chemicals Corp.). Aryl diphosphites or diphosphonites (i.e., contains at least two phosphorus atoms per phosphite molecule may also be employed in the stabilizing system and may include, for instance, distearyl pentaerythritol diphosphite, diisodecyl pentaerythritol diphosphite, bis(2,4 di-tert-butylphenyl) pentaerythritol diphosphite (Irgafos 126 available from Ciba); bis(2,6-di-tert-butyl-4-methylphenyl)pentaerythritol diphosphite; bisisodecyloxypentaerythritol diphosphite, bis(2,4-di-tert-butyl-6-methylphenyl)pentaerythritol diphosphite, bis(2,4,6-tri-tert-butylphenyl)pentaerythritol diphosphite, tetrakis(2,4-di-tert-butylphenyl)4,4′-biphenylene-diphosphonite (Sandostab™ P-EPQ, available from Clariant) and bis(2,4-dicumylphenyl)pentaerythritol diphosphite (Doverphos® S-9228).

Organophosphorous compounds may constitute from about 0.01 wt. % to about 2 wt. %, in some embodiments from about 0.05 wt. % to about 1 wt. %, and in some embodiments, from about 0.1 wt. % to about 0.5 wt. % of the polymer composition.

In addition to those mentioned above, secondary amines may also be employed in the composition. The secondary amines may be aromatic in nature, such as N-phenyl naphthylamines (e.g., Naugard® PAN from Uniroyal Chemical); diphenylamines, such as 4,4′-bis(dimethylbenzyl)-diphenylamine (e.g., Naugard® 445 from Uniroyal Chemical); p-phenylenediamines (e.g., Wingstay® 300 from Goodyear); quinolones, and so forth. Particularly suitable secondary amines are oligomeric or polymeric amines, such as homo- or copolymerized polyamides. Examples of such polyamides may include nylon 3 (poly-β-alanine), nylon 6, nylon 10, nylon 11, nylon 12, nylon 6/6, nylon 6/9, nylon 6/10, nylon 6111, nylon 6/12, polyesteramide, polyamideimide, polyacrylamide, and so forth. In one particular embodiment, the amine is a polyamide terpolymer having a melting point in the range from 120° C. to 220° C. Suitable terpolymers may be based on the nylons selected from the group consisting of nylon 6, nylon 6/6, nylon 6/9, nylon 6/10 and nylon 6/12, and may include nylon 6-66-69; nylon 6-66-610 and nylon 6-66-612. One example of such a nylon terpolymer is a terpolymer of nylon 6-66-610 and is commercially available from Du Pont de Nemours under the designation Elvamide® 8063R. Secondary amines may constitute from about 0.01 wt. % to about 2 wt. %, of the entire polymer composition.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

The compositions of the present disclosure can be compounded and formed into polymer articles using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 150 to 300° C., such as from 200 to 280° C., such as from 220 to 270° C. or 240 to 260° C. However, such processing should be conducted for each respective composition at a desired temperature to minimize any polymer degradation.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent tribological behavior and mechanical properties. Consequently, the polymer articles can be used for several applications where low wear and excellent gliding properties are desired.

Polymer compositions in accordance with the present disclosure can have excellent flame resistant properties in addition to physical properties. For instance, when tested according to Underwriters Laboratories Test 94 according to the Vertical Burn Test, test plaques made according to the present disclosure can have a UL-94 rating of V-0, even when tested at a thickness of 1.5 mm or even at a thickness of 0.8 mm.

Of particular advantage, flame resistant polymer compositions can be formulated in accordance with the present disclosure with excellent flow properties. For example, when tested according to ISO Test 1133 at a temperature of 250° C. and at a load 2.16 kg, the overall polymer composition can have a melt flow rate of greater than about 3 cm³/10 min, such as greater than about 4 cm³/10 min, such as greater than about 5 cm³/10 min, such as greater than about 6 cm³/10 min, such as greater than about 7 cm³/10 min, such as greater than about 8 cm³/10 min, such as greater than about 9 cm³/10 min, such as greater than about 10 cm³/10 min. The melt flow rate is generally less than about 50 cm³/10 min.

The present disclosure may be better understood with reference to the following examples.

### Example

Various polymer compositions were formulated in accordance with the present disclosure and tested for various properties. The following results were obtained.

TABLE 1

| | Norm | | | | | | | | | | |
|---|---|---|---|---|---|---|---|---|---|---|---|
| Formulation | ISO | Unit | 1 | 2 | 3 | 4 | 5 | 6 | 7 | 8 | 9 |
| Polybutylene Terephthalate | | % | 66.6 | 51.5 | 51.8 | 51.5 | 56.5 | 50.5 | 45.0 | 42.5 | 50.0 |
| (MVR40 cm³/10 min) (<20 | | | | | | | | | | | |
| mmol COOH/kg) | | | | | | | | | | | |
| Polybutylene Terephthalate | | % | 1.5 | 1.5 | 1.5 | 1.5 | 1.5 | 1.5 | 1.5 | 1.5 | 1.5 |
| (blending aid) | | | | | | | | | | | |
| Glass fibers with sizing | | % | 30.0 | 26.0 | 25.0 | 25.0 | 25.0 | 25.0 | 25.0 | 25.0 | 26.0 |
| composition containing | | | | | | | | | | | |
| hydrolysis resistant agent | | | | | | | | | | | |
| Aluminum diethyl phosphinate | | % | 0 | 13.3 | 13.3 | 13.3 | 10.0 | 13.3 | 15.0 | 13.3 | 13.3 |
| Melamine cyanurate | | % | 0 | 6.7 | 6.7 | 6.7 | 5.0 | 6.7 | 7.5 | 6.7 | 6.7 |
| Pentaerythritol tetrakis(Beta- | | % | 0.2 | 0.1 | 0.1 | 0.1 | 0.1 | 0.1 | 0.1 | 0.1 | 0.1 |
| Laurylthiopropionate) | | | | | | | | | | | |
| Pentaerythritol tetrakis(3-(3,5- | | % | 0.2 | 0.1 | 0.1 | 0.1 | 0.1 | 0.1 | 0.1 | 0.1 | 0.1 |
| di-tert-butyl-4- | | | | | | | | | | | |
| hydroxyphenyl)propionate) | | | | | | | | | | | |
| Bis-(2,4-di-t-butylphenol) | | % | 0 | 0.2 | 0.2 | 0.2 | 0.2 | 0.2 | 0.2 | 0.2 | 0.2 |
| Pentaerythritol Diphosphite | | | | | | | | | | | |
| Montanic acid triol ester | | % | 0 | 0.3 | 0.3 | 0.3 | 0.3 | 0.3 | 0.3 | 0.3 | 0.3 |
| Titanate coupling agent | | % | 0 | 0.3 | 0 | 0.3 | 0.3 | 0.3 | 0.3 | 0.3 | 0.3 |
| HR Additive Type I | | % | 0 | 0 | 1.0 | 1.0 | 1.0 | 2.0 | 0 | 0 | 0 |
| HR Additive Type II | | % | 1.5 | 0 | 0 | 0 | 0 | 0 | 0 | 0 | 1.5 |
| HR Additive Type III | | % | 0 | 0 | 0 | 0 | 0 | 0 | 0 | 10.0 | 0 |
| Copolymer of ethylene and | | % | 0 | 0 | 0 | 0 | 0 | 0 | 5.0 | 0 | 0 |
| ethyl acrylate containing 16% | | | | | | | | | | | |
| ethyl acrylate | | | | | | | | | | | |
| Total | | % | 100 | 100 | 100 | 100 | 100 | 100 | 100 | 100 | 100 |
| MVR 250° C./5 kg | 1133 | cm³/10 | 10 | 16 | 5 | 7 | 12.2 | 7 | n/a | 6.8 | 18.5 |
| | | min | | | | | | | | | |
| Vertical Burning (1.5 mm) | UL94 | Rating | — | V0 | V0 | V0 | No | V0 | V0 | V0 | V0 |
| | | | | | | | rating | | | | |
| Vertical Burning (0.8 mm) | UL94 | Rating | — | V0 | No | V0 | V1 | No | V1 | V0 | V1 |
| | | | | | rating | | | rating | | | |
| CTI | IEC | V | 450 | 450 | 450 | 450 | 450 | 450 | 450 | 450 | 450 |
| | 60112 | | | | | | | | | | |

HR Additive Type I was a polycarbodiimide: Lubio AS3-SP by Schaeffe Additive Systems. HR Additive Type II was an epoxy-based compound: Epon 1002F by Hexion. HR Additive Type III was a polycarbodiimide: Stabaxol KE9193 masterbatch containing Stabaxol P100 by Lanxess. CTI testing for all specimens was done only at 450V.

The titanate coupling agent used was titanium IV 2-propanolato,tris(dioctyl)phosphato-O.

As shown above, Sample Nos. 3 through 8 all displayed excellent fire retardant properties. Sample No. 4 and Sample No. 8 displayed excellent fire retardant properties even at a plaque thickness of 0.8 mm.

The above formulations were molded into test samples and subjected to the Hydrolysis Test. During the Hydrolysis Test, a sample was placed in a pressure cooker at 121° C. for 96 hours and for 168 hours. The initial mechanical properties of the sample was then compared to samples that were subjected to the Hydrolysis Test at the different time intervals. The following results were obtained:

TABLE 2

| Property before storage | | | | | | | | | | |
|---|---|---|---|---|---|---|---|---|---|---|
| and after storage at | | | | | | | | | | |
| 121° C. for 96 and 168 | | | % | | % | | % | | % | |
| hours in a pressure cooker | Unit | 1 | retention | 2 | retention | 3 | retention | 4 | retention | 5 |
| Tensile Modulus | MPa | 9746 | 100% | 9971 | 100% | 11033 | 100% | 11389 | 100% | 10960 |
| Tensile Modulus (96 h, | | 9684 | 99% | 9293 | 93% | 10216 | 93% | 10432 | 92% | 9882 |
| 121° C.) | | | | | | | | | | |
| Tensile Modulus (168 h, | | 9488 | 97% | 8914 | 89% | 10090 | 91% | 10586 | 93% | 10070 |
| 121° C.) | | | | | | | | | | |
| Break Stress | MPa | 156.5 | 100% | 113.0 | 100% | 114.2 | 100% | 115.5 | 100% | 122.5 |
| Break Stress (96 h, 121° C.) | | 126.0 | 81% | 49.0 | 43% | 94.27 | 83% | 83.7 | 72% | 85.9 |
| Break Stress (168 h, 121° C.) | | 121.0 | 77% | 32.0 | 28% | 42 | 37% | 85.8 | 74% | 92.3 |
| Break Strain | % | 3.10 | 100% | 2.10 | 100% | 2.00 | 100% | 2.09 | 100% | 2.23 |
| Break Strain (96 h, 121° C.) | | 1.87 | 60% | 0.62 | 30% | 1.71 | 86% | 1.32 | 63% | 1.33 |
| Break Strain (168 h, 121° C.) | | 1.72 | 55% | 0.47 | 22% | 0.54 | 27% | 1.35 | 65% | 1.47 |
| Charpy notched strength @ | kJ/m² | 11.1 | 100% | 7.7 | 100% | 8 | 100% | 7.9 | 100% | 9 |
| 23° C. | | | | | | | | | | |
| CN (96 h, 121° C.) | | 8 | 72% | 4.9 | 64% | 6.1 | 76% | 5 | 63% | 5.2 |
| CN (168 h, 121° C.) | | 7.8 | 70% | 4.7 | 61% | 4.5 | 56% | 5.1 | 65% | 5.2 |

| Property before storage | | | | | | | | | |
|---|---|---|---|---|---|---|---|---|---|
| and after storage at | | | | | | | | | |
| 121° C. for 96 and 168 | % | | % | | % | | % | | % |
| hours in a pressure cooker | retention | 6 | retention | 7 | retention | 8 | retention | 9 | retention |
| Tensile Modulus | 100% | 11455 | 100% | 10524 | 100% | 11231 | 100% | 10267 | 100% |
| Tensile Modulus (96 h, | 90% | 10567 | 92% | 9650 | 92% | 10388 | 92% | 9661 | 94% |
| 121° C.) | | | | | | | | | |
| Tensile Modulus (168 h, | 92% | 10580 | 92% | 9163 | 87% | 10158 | 90% | 8523 | 83% |
| 121° C.) | | | | | | | | | |
| Break Stress | 100% | 115.5 | 100% | 82.45 | 100% | 114 | 100% | 115.2 | 100% |
| Break Stress (96 h, 121° C.) | 70% | 81.6 | 71% | 43.8 | 53% | 84 | 74% | 57 | 49% |
| Break Stress (168 h, 121° C.) | 75% | 88.75 | 77% | 30.75 | 37% | 33.17 | 29% | 33 | 29% |
| Break Strain | 100% | 1.98 | 100% | 1.13 | 100% | 2.00 | 100% | 1.70 | 100% |
| Break Strain (96 h, 121° C.) | 60% | 1.24 | 63% | 0.54 | 48% | 1.34 | 67% | 0.67 | 39% |
| Break Strain (168 h, 121° C.) | 66% | 1.42 | 72% | 0.40 | 35% | 0.38 | 19% | 0.52 | 31% |
| Charpy notched strength @ | 100% | 8 | 100% | 8.1 | 100% | 8.1 | 100% | 8.3 | 100% |
| 23° C. | | | | | | | | | |
| CN (96 h, 121° C.) | 58% | 5.3 | 66% | 5.5 | 68% | 5.1 | 63% | 6.2 | 75% |
| CN (168 h, 121° C.) | 58% | 5.4 | 68% | 4.8 | 59% | 4 | 49% | 5.2 | 63% |

As shown above, polymer compositions made in accordance with the present disclosure showed excellent hydrolysis resistance. For example, the Charpy notched strength of the polymer composition made in accordance with the present disclosure at 23° C. decreased by no more than 40%, such as by no more than about 30% after 96 hours and decreased by no more than about 55%, such as by no more than about 50% after 168 hours. The tensile modulus of the polymer composition decreased by no more than about 9%, such as by no more than about 8%, after 96 hours and decreased by no more than about 12%, such as by no more than about 11% after 168 hours, when tested at 121° C.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a polyester polymer, the polyester polymer having carboxyl end groups in an amount less than about 20 mmol/kg, the polyester polymer being present in the polymer composition in an amount greater than about 40% by weight;
a flame retardant composition contained within the polymer composition, the flame retardant composition comprising a non-halogen flame retardant; and
reinforcing fibers dispersed throughout a polymer matrix formed from the polyester polymer, the reinforcing fibers being coated with a sizing composition comprising a sizing agent combined with a hydrolysis resistant agent.

2. A polymer composition as defined in claim 1, wherein the polyester polymer comprises a polybutylene terephthalate polymer.

3. A polymer composition as defined in claim 1, further comprising a polycarbodiimide.

4. A polymer composition as defined in claim 3, wherein the wherein the polycarbodiimide has a weight average molecular weight of 10,000 g/mol or greater.

5. A polymer composition as defined in claim 1, wherein the reinforcing fibers comprise glass fibers, the sizing agent comprising a silane.

6. A polymer composition as defined in claim 1, wherein the sizing composition is present on the reinforcing fibers in an amount from about 0.1% to about 4% by weight of the reinforcing fibers.

7. A polymer composition as defined in claim 1, wherein the reinforcing fibers have an average fiber length of from about 1 mm to about 5 mm and have an average fiber diameter of from about 8 microns to about 12 microns.

8. A polymer composition as defined in claim 1, wherein the flame retardant composition comprises a metal phosphinate, and a nitrogen-containing synergist.

9. A flame resistant polymer composition as defined in claim 8, wherein the flame retardant composition further comprises aluminum phosphite, wherein the metal phosphinate comprises an aluminum diethyl phosphinate, wherein the nitrogen-containing synergist comprises melamine cyanurate.

10. A flame resistant polymer composition as defined in claim 1, wherein the polymer composition further contains an organometallic compatibilizer.

11. Aflame resistant polymer composition as defined in claim 10, wherein the organometallic compatibilizer comprises a titanate.

12. Aflame resistant polymer composition as defined in claim 10, wherein the organometallic compatibilizer comprises titanium IV 2-propanolato,tris(dioctyl)phosphato-O.

13. A flame resistant polymer composition as defined in claim 10, wherein the organometallic compatibilizer is present in the polymer composition in an amount from about 0.05% to about 2.5% by weight.

14. A flame resistant polymer composition as defined in claim 1, wherein the polymer composition further contains an ester of a carboxylic acid.

15. A flame resistant polymer composition as defined in claim 1, wherein the polymer composition has a melt flow rate of at least 4 cm³/10 min when tested at a temperature of 250° C. and at a load of 2.16 kg.

16. A flame resistant polymer composition as defined in claim 1, wherein the polymer composition, when tested according to a Vertical Burn Test according to Underwriters Laboratories Test 94, has a rating of V-0 when tested at a thickness of 1.5 mm.

17. A polymer composition as defined in claim 1, wherein the reinforcing fibers comprise glass fibers, the glass fibers being present in the polymer composition in an amount from about 10% to about 40% by weight.

18. A polymer composition as defined in claim 1, wherein when the polymer composition is subjected to the Hydrolysis Test at 121° C., a tensile modulus of the polymer composition reduces by no more than about 50% after 168 hours.

19. A polymer composition as defined in claim 1, wherein when the polymer composition is subjected to the Hydrolysis Test at 121° C., a Charpy notched strength at 23° C. of the polymer composition reduces by no more than about 50% after 168 hours.

20. An electrical connector that comprises at least two opposing walls between which a passageway is defined for receiving a contact element, the walls being formed from a polymer composition as defined in claim 1.
